(19) United States
(12) Patent Application Publication
(10) Pub. No.: US 2024/0272897 A1
(43) Pub. Date: Aug. 15, 2024

(54) MOBILE OBJECT CONTROL DEVICE, MOBILE OBJECT CONTROL METHOD, AND RECORDING MEDIUM

(71) Applicant: HONDA MOTOR CO., LTD., Tokyo (JP)

(72) Inventor: Hisahiro Kato, Tokyo (JP)

(21) Appl. No.: 18/533,656

(22) Filed: Dec. 8, 2023

(30) Foreign Application Priority Data
Feb. 15, 2023 (JP) 2023-021286

(51) Int. Cl. G06F 8/656; G06F 8/71; G06F 11/14

(52) U.S. Cl. CPC G06F 8/656; G06F 8/71; G06F 11/1433

(57) ABSTRACT

A mobile object control device includes: a first processor; a first memory; a second processor; and a second memory. The first processor outputs a first software updatable notification to the second processor and the second processor outputs a second software updatable notification to the first processor. The first processor executes first switching processing of switching the first software to be used from the old version to the new version and the second processor executes second switching processing of switching the second software to be used from the old version to the new version when the first processor recognizes the second software updatable notification and the second processor recognizes the first software updatable notification.

### INCORPORATION BY REFERENCE

The present application claims priority under 35 U.S.C. § 119 to Japanese Patent Application No. 2023-021286 filed on Feb. 15, 2023. The content of the application is incorporated herein by reference in its entirety.

### BACKGROUND OF THE INVENTION

### Field of the Invention

The present invention relates to a mobile object control device, a mobile object control method, and a recording medium.

### Description of the Related Art

Conventionally, technology that supports the update of software in a control device mounted on a mobile object such as a vehicle has been proposed. For example, Japanese Patent Laid-Open No. 2019-144669 discloses a configuration in which a region for storing a program that is being executed and a region for storing an update program are set in a storage unit that stores a program to be executed by an electronic control unit (ECU) mounted on a vehicle. This configuration is supposed to allow the update program to be stored in the storage unit even while the program is being executed and make it possible to ease a restriction on a timing of updating the program.

Software such as a program to be used by a mobile object control device includes important software that takes charge in the basic actuation of a mobile object, which may thus obstruct an operation of the mobile object when the software is not normally updated. Accordingly, an object of the present application is to update the software in the mobile object control device more reliably.

The present application aims at promoting safety to achieve the object described above. Moreover, the present application improves traffic safety still more to contribute to the development of a sustainable transportation system.

### SUMMARY OF THE INVENTION

A first aspect for achieving the object described above includes a mobile object control device including: a first processor; a first memory in which first software to be used by the first processor is saved; a second processor; and a second memory in which second software to be used by the second processor is saved. The first processor outputs a first software updatable notification to the second processor when the first processor saves the first software in a new version in the first memory to make the first software switchable from an old version to the new version. The second processor outputs a second software updatable notification to the first processor when the second processor saves the second software in a new version in the second memory to make the second software switchable from an old version to the new version. The first processor executes first switching processing of switching the first software to be used from the old version to the new version and the second processor executes second switching processing of switching the second software to be used from the old version to the new version when the first processor recognizes the second software updatable notification and the second processor recognizes the first software updatable notification.

In the mobile object control device described above, the first processor may include a power-on/off reception unit configured to receive an instruction to switch the mobile object between a power-on state and a power-off state, and the first processor may be configured to save the first software in the new version in the first memory and output a power-off switching instruction reception notification to the second processor when the first processor receives an instruction to switch the mobile object to the power-off state by using the power-on/off reception unit, and the second processor may be configured to save the second software in the new version in the second memory when the second processor recognizes the power-off switching instruction reception notification.

In the mobile object control device described above, the second processor is connected to a power switching circuit configured to switch the power-on state and the power-off state and the second processor may be configured to switch the mobile object to the power-off state by using the power switching circuit when the second processor recognizes the power-off switching instruction reception notification, and the first processor may be configured to receive the instruction to switch the mobile object to the power-off state by using the power-on/off reception unit and the first processor may be configured to save the first software in the new version in the first memory when the first processor recognizes that the mobile object is switched to the power-off state on the basis of a status of detection by a switching detection unit configured to detect an actuation state of the power switching circuit.

In the mobile object control device described above, a region in which the first software in the old version is saved and a region in which the first software in the new version is saved are set in the first memory, a region in which the second software in the old version is saved and a region in which the second software in the new version is saved are set in the second memory, the first processor may be configured to save the first software in the new version in the first memory while the first processor keeps the first software in the old version saved in the first memory and the first processor may be configured to continue using the first software in the old version without outputting the first software updatable notification to the second processor when the first processor fails to save the first software in the new version in the first memory, and the second processor may be configured to save the second software in the new version in the second memory while the second processor keeps the second software in the old version saved in the second memory and the second processor may be configured to continue using the second software in the old version without outputting the second software updatable notification to the first processor when the second processor fails to save the second software in the new version in the second memory.

A second aspect for achieving the object described above includes a mobile object control method that is executed by a mobile object control device including a first processor, a first memory in which first software to be used by the first processor is saved, a second processor, and a second memory in which second software to be used by the second processor is saved. The mobile object control method includes: a step of outputting, by the first processor, a first software updatable notification to the second processor when the first processor saves the first software in a new version in the first memory to make the first software switchable from an old version to the new version; a step of outputting, by the second processor, a second software updatable notification to the first processor when the second processor saves the second software in a new version in the second memory to make the second software switchable from an old version to the new version; and a step of executing, by the first processor, first switching processing of switching the first software to be used from the old version to the new version and executing, by the second processor, second switching processing of switching the second software to be used from the old version to the new version when the first processor recognizes the second software updatable notification and the second processor recognizes the first software updatable notification.

A third aspect for achieving the object described above includes a non-transitory recording medium storing a program that is executed by a first processor and a second processor in a mobile object control device including the first processor, a first memory in which first software to be used by the first processor is saved, the second processor, and a second memory in which second software to be used by the second processor is saved. The program causes: the first processor to execute processing of outputting a first software updatable notification to the second processor when the first processor saves the first software in a new version in the first memory to make the first software switchable from an old version to the new version; the second processor to execute processing of outputting a second software updatable notification to the first processor when the second processor saves the second software in a new version in the second memory to make the second software switchable from an old version to the new version; and the first processor and the second processor to respectively execute first switching processing of switching the first software to be used from the old version to the new version and second switching processing of switching the second software to be used from the old version to the new version when the first processor recognizes the second software updatable notification and the second processor recognizes the first software updatable notification.

### Advantageous Effects of Invention

The mobile object control device, the mobile object control method, and the program described above each make it possible to update the software in the mobile object control device more reliably and improve traffic safety still more.

### BRIEF DESCRIPTION OF THE DRAWINGS

FIG. 1 is a configuration diagram of a mobile object control device;

FIG. 2 is a flowchart of software update processing in the mobile object control device; and

FIG. 3 is a timing chart of the software update processing in the mobile object control device.

### DETAILED DESCRIPTION OF THE PREFERRED EMBODIMENTS

### 1. Configuration of Mobile Object Control Device

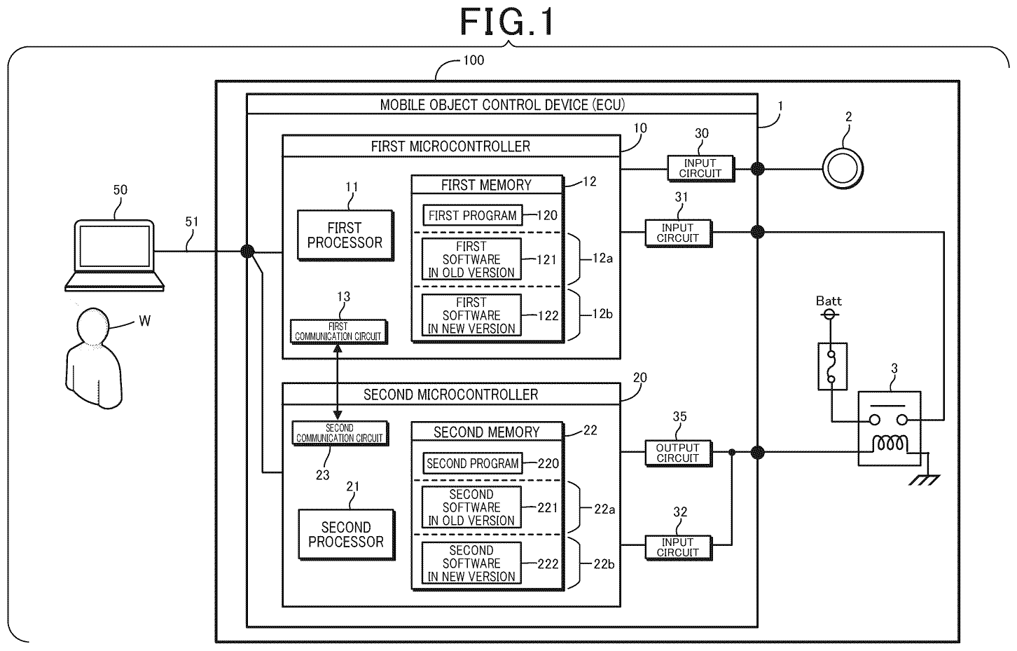

A configuration of a mobile object control device 1 according to the present embodiment will be described with reference to FIG. 1. The mobile object control device 1 is an electronic control unit (ECU) that controls the actuation of a mobile object 100. The mobile object 100 is a vehicle, a flying object, a vessel, or the like.

The mobile object control device 1 includes a first microcontroller 10 and a second microcontroller 20. The first microcontroller 10 includes a first processor 11, a first memory 12, a first communication circuit 13, and the like, and the second microcontroller 20 includes a second processor 21, a second memory 22, a second communication circuit 23, and the like. A first program 120 to be executed by the first processor 11, first software 121 in an old version, and first software 122 in a new version are saved in the first memory 12.

The first program 120 is a program to be executed by the first processor 11 for controlling a basic operation of the first microcontroller 10. The first software 121 in the old version and the first software 122 in the new version are software to be used by the first processor 11 and each include a program for controlling the mobile object 100, a data set to be used to control the mobile object 100, and the like.

A second program 220, second software 221 in an old version, and second software 222 in a new version are saved in the second memory 22. The second program 220 is a program to be executed by the second processor 21 for controlling a basic operation of the second microcontroller 20. The second software 221 in the old version and the second software 222 in the new version are software to be used by the second processor 21 and each include a program for controlling the mobile object 100, a data set to be used to control the mobile object 100, and the like.

The first software 121 in the old version is saved in a region 12a of the first memory 12 and the first software 122 in the new version is saved in a region 12b of the first memory 12. In addition, the second software 221 in the old version is saved in a region 22a of the second memory 22 and the second software 222 in the new version is saved in a region 22b of the second memory 22.

In this way, the configuration is adopted that allows both the old versions and the new versions of the first software and the second software to be saved, thereby making it possible to continue controlling the mobile object 100 by using the first software and second software in the old versions as described below when the update from the old versions to the new versions results in failure.

A start/stop (SS) switch 2 that instructs the mobile object 100 to switch between ignition (IG)-on (power-on state) and IG-off (power-off state) is connected to the first microcontroller 10 and an operation signal of the SS switch 2 is inputted to the first microcontroller 10 through an input circuit 30. An IG relay 3 is connected to the second microcontroller 20 and the IG relay 3 is controlled to turn on and off by using a control signal outputted from the second microcontroller 20 through an output circuit 35, which switches the mobile object 100 between IG-on and IG-off.

An output unit of the output circuit 35 is connected to an input circuit 32 and a detection signal of the output state (the on/off state of the IG relay 3) of the output circuit 35 is inputted to the second microcontroller 20 from the input circuit 32. An output unit of the IG relay 3 is connected to an input circuit 31 and an on/off detection signal of the IG relay 3 is inputted to the first microcontroller 10 from the input circuit 31.

The mobile object control device 1 is connectable to a terminal device 50 by a connection cable 51 and a worker W is able to maintain the mobile object 100 by operating the terminal device 50. The following describes processing of updating the first software 121 in the old version to the first software 122 in the new version and updating the second software 221 in the old version to the second software 222 in the new version in accordance with an operation on the terminal device 50 by the worker W.

### 2. Processing of Updating First Software and Second Software

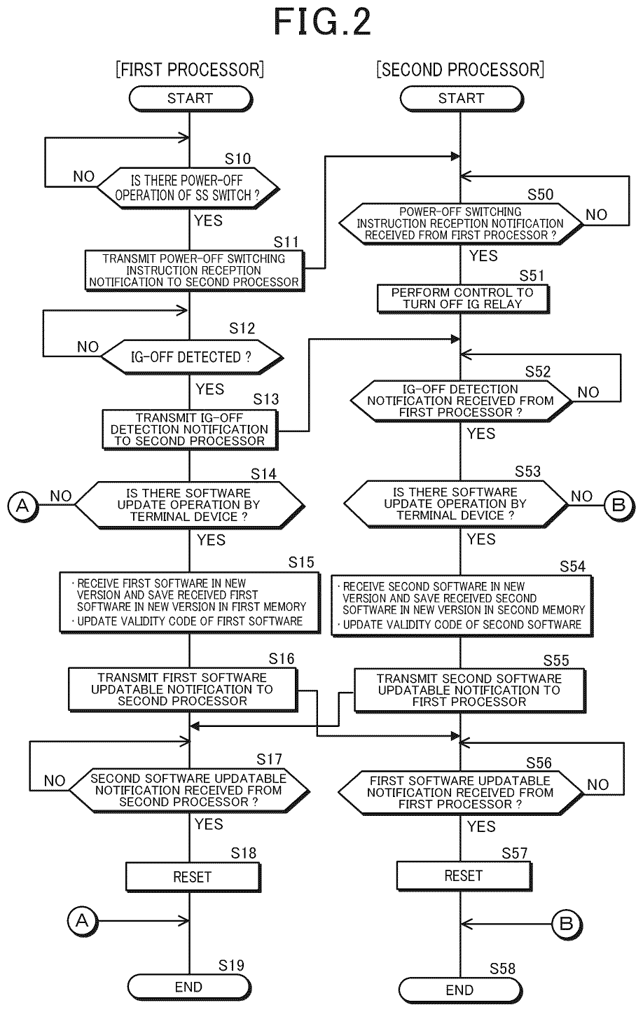

The processing of updating the first software and the second software to be executed by the first processor 11 and the second processor 21 will be described in accordance with the flowchart illustrated in FIG. 2. The processing to be executed by the first processor 11 and the second processor 21 in the flowchart of FIG. 2 corresponds to steps in the mobile object control method according to the present disclosure and corresponds to processing to be executed by the program according to the present disclosure.

When recognizing an operation signal inputted from the input circuit 30 and receiving a power-off operation (IG-off operation) of the SS switch 2 in step S10 of FIG. 2, the first processor 11 advances the processing to step S11. In step S11, the first processor 11 transmits, to the second processor 21, a power-off switching instruction reception notification indicating that the power-off operation of the SS switch 2 is performed.

When receiving the power-off switching instruction reception notification transmitted from the first processor 11 in step S50, the second processor 21 advances the processing to step S51. In step S51, the second processor 21 turns the IG relay 3 off (cut-off state) by switching an on-control signal to be outputted to the IG relay 3 through the output circuit 35 to an off-control signal, thereby causing the mobile object 100 to enter an IG-off state. The IG relay 3 is turned off to input an IG-relay-off signal to the first microcontroller 10 from the input circuit 31 and the first processor 11 detects IG-off.

When detecting IG-off in step S12, the first processor 11 advances the processing to step S13. In step S13, the first processor 11 transmits, to the second processor 21, an IG-off detection notification indicating that IG-off is detected. In subsequent step S14, the first processor 11 determines the presence or absence of a software update operation by the terminal device 50, and advances the processing to step S15 in the presence of an update operation and advances the processing to step S19 in the absence of an update operation.

In step S15, the first processor 11 receives the first software 122 in the new version transmitted from the terminal device 50 and saves the transmitted first software 122 in the new version in the first memory 12. When it is confirmed that the first software 122 in the new version saved in the first memory 12 is normal through communication with the terminal device 50, the first processor 11 then updates the validity code of the first software from the old version code to a new version code. In subsequent step S16, the first processor 11 transmits, to the second processor 21, a first software updatable notification indicating that the first software 121 in the old version is updatable to the first software in the new version.

Here, the first software 122 in the new version is saved in the first memory 12 while the first software 121 in the old version is kept saved in the first memory 12. When it is not possible for the first processor 11 to confirm that the first software 122 in the new version saved in the first memory 12 is normal (in the case of failure in saving the first software 122 in the new version), the first processor 11 then notifies the terminal device 50 of failure in obtaining the first software 122 in the new version. In this case, the processing in step S16 and the following steps is not executed and the first processor 11 continues using the first software 121 in the old version to control the actuation of the mobile object 100.

When receiving the IG-off detection notification transmitted from the first processor 11 in step S52, the second processor 21 advances the processing to step S53. In step S53, the second processor 21 determines the presence or absence of a software update operation by the terminal device 50, and advances the processing to step S54 in the presence of an update operation and advances the processing to step S58 in the absence of an update operation.

In step S54, the second processor 21 receives the second software 222 in the new version transmitted from the terminal device 50 and saves the transmitted second software 222 in the new version in the second memory 22. When it is confirmed that the second software 222 in the new version saved in the second memory 22 is normal through communication with the terminal device 50, the second processor 21 then updates the validity code of the second software from the old version code to a new version code. In subsequent step S55, the second processor 21 transmits, to the first processor 11, a second software updatable notification indicating that the second software 221 in the old version is updatable to the second software 222 in the new version.

Here, the second software 222 in the new version is saved in the second memory 22 while the second software 221 in the old version is kept saved in the second memory 22. When it is not possible for the second processor 21 to confirm that the second software 222 in the new version saved in the second memory 22 is normal (in the case of failure in saving the second software 222 in the new version), the second processor 21 then notifies the terminal device 50 of failure in obtaining the second software 222 in the new version. In this case, the processing in step S55 and the following steps is not executed and the second processor 21 continues using the second software 221 in the old version to control the actuation of the mobile object 100.

When receiving the second software updatable notification from the second processor 21 in step S17, the first processor 11 advances the processing to step S18 to execute reset processing. In addition, when receiving the first software updatable notification from the first processor 11 in step S56, the second processor 21 advances the processing to step S57 to execute reset processing.

In this way, the first processor 11 and the second processor 21 are reset to switch the first software and the second software from the old versions to the new versions at timings at which the first processor 11 and the second processor 21 both recognize that the first software 122 in the new version is normally saved in the first memory 12 and the second software 222 in the new version is normally saved in the second memory 22. This makes it possible to update the first software and the second software from the old versions to the new versions more reliably.

The processing of the first processor 11 to switch the first software 121 in the old version to the first software 122 in the new version through the reset processing corresponds to first switching processing according to the present disclosure. The processing of the second processor 21 to switch the second software 221 in the old version to the second software 222 in the new version through the reset processing corresponds to second switching processing according to the present disclosure.

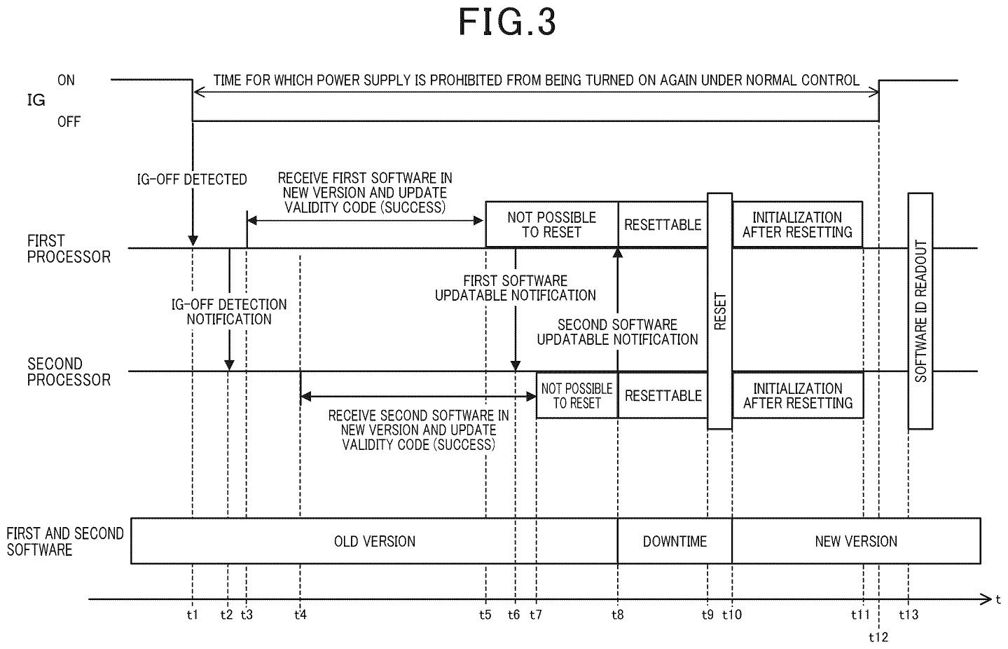

Next, FIG. 3 is a timing chart illustrating, by using a common time axis t, the transition of the switching between IG-on and IG-off, the actuation of the first processor 11 and the second processor 21, and the version switching between the valid first software and second software when the processing according to the flowchart illustrated in FIG. 2 described above is executed.

First, the first processor 11 detects IG-off at t1 when the first processor 11 receives an off operation of the SS switch 2 by the worker W, the second processor 21 turns off the IG relay 3, and an IG-off detection signal outputted from the input circuit 31 is inputted to the first microcontroller 10.

The first processor 11 transmits an IG-off detection notification to the second processor 21 at t2, and receives the first software 122 in the new version transmitted from the terminal device 50 and saves the received first software 122 in the new version in the first memory 12 between t3 and t5. When it is possible to confirm that the first software 122 in the new version is normally saved, the first processor 11 then switches the validity code of the first software from the old version code to the new version code. The first processor 11 transmits a first software updatable notification to the second processor 21 at t6.

When the second processor 21 receives the IG-off detection notification from the first processor 11 at t2, the second processor 21 receives the second software 222 in the new version transmitted from the terminal device 50 and saves the received second software 222 in the new version in the second memory 22 between t4 and t7. When it is possible to confirm that the second software 222 in the new version is normally saved, the second processor 21 then switches the validity code of the second software from the old version code to the new version code. The second processor 21 transmits a second software updatable notification to the first processor 11 at t8.

It is not possible to reset the first processor 11 and the second processor 21 before the second processor 21 transmits a second software updatable notification and the first processor 11 receives the second software updatable notification at t8. At t8, the first processor 11 receives the second software updatable notification to cause the first processor 11 and the second processor 21 to enter a resettable state in which the first processor 11 and the second processor 21 are reset to update the first software and the second software from the old versions to the new versions.

The first processor 11 and the second processor 21 are reset, and the first processor 11 switches the first software 121 in the old version to the first software 122 in the new version and the second processor 21 switches the second software 221 in the old version to the second software 222 in the new version between t9 and t10.

The period between t8 and t10 is downtime (period in which it is not possible to actuate the first software and the second software) before the first software and the second software are updated from the old versions to the new versions. At t10 at which resetting is performed, the first software and the second software are switched to the new versions.

The first processor 11 and the second processor 21 perform initialization after resetting between t10 and t1l. The worker W reads out the identifications (IDs) of the valid first software and second software by operating the terminal device 50 at t13 and confirms that the first software used by the first processor 11 and the second software used by the second processor 21 are switched to the new versions (the update results in success).

### 3. Other Embodiments

In the embodiment described above, the configuration has been exemplified in which the IG relay 3 is connected to the second microcontroller 20 as illustrated in FIG. 1, the second processor 21 performs control to turn on/off the IG relay 3, and the first processor 11 detects IG-on and IG-off on the basis of outputs of the IG relay 3. As another embodiment, the first processor 11 may switch IG-on and IG-off in other configurations such as the first processor 11 performing control to turn on/off the IG relay 3.

In the embodiment described above, the first software and the second software are switched from the old versions to the new versions at a timing at which IG-on is switched to IG-off as illustrated in FIGS. 2 and 3, but the first software and the second software may be switched from the old versions to the new versions at other timings.

In the embodiment described above, the first memory 12 is provided with the regions 12a and 12b in which the first software 121 in the old version and the first software 122 in the new version are saved and the second memory 22 is provided with the regions 22a and 22b in which the second software 221 in the old version and the second software 222 in the new version are saved as illustrated in FIG. 1, and switching to the first software 122 and the second software 222 in the new versions is performed while the first software 121 and the second software 221 in the old versions are kept saved. As another embodiment, such a configuration may be omitted in which the new and old first software and second software are saved in the memories.

It is to be noted that FIG. 1 is a schematic diagram in which the configuration of the mobile object control device 1 is divided in accordance with the chief processing contents for facilitating the understandings of the invention according to the present application, and that the mobile object control device 1 may be configured in accordance with other divisions. In addition, the processing of each of the components may be executed by one hardware unit or executed by a plurality of hardware units. In addition, the processing by each of the components illustrated in FIG. 2 may be executed by one program or executed by a plurality of programs.

### 4. Configurations Supported by Embodiments Above

The embodiments described above are specific examples of the following configurations.

(Configuration 1) A mobile object control device including: a first processor; a first memory in which first software to be used by the first processor is saved; a second processor; and a second memory in which second software to be used by the second processor is saved, in which the first processor outputs a first software updatable notification to the second processor when the first processor saves the first software in a new version in the first memory to make the first software switchable from an old version to the new version, the second processor outputs a second software updatable notification to the first processor when the second processor saves the second software in a new version in the second memory to make the second software switchable from an old version to the new version, and the first processor executes first switching processing of switching the first software to be used from the old version to the new version and the second processor executes second switching processing of switching the second software to be used from the old version to the new version when the first processor recognizes the second software updatable notification and the second processor recognizes the first software updatable notification.

According to the mobile object control device according to Configuration 1, while the first processor and the second processor respectively recognize that the first software in the new version is saved in the first memory and that the second software in the new version is saved in the second memory, the first processor switches the first software from the old version to the new version and the second processor switches the second software from the old version to the new version. This makes it possible to update the software in the mobile object control device more reliably and improve traffic safety still more.

(Configuration 2) The mobile object control device according to Configuration 1, in which the first processor includes a power-on/off reception unit configured to receive an instruction to switch the mobile object between a power-on state and a power-off state, and the first processor saves the first software in the new version in the first memory and outputs a power-off switching instruction reception notification to the second processor when the first processor receives an instruction to switch the mobile object to the power-off state by using the power-on/off reception unit, and the second processor saves the second software in the new version in the second memory when the second processor recognizes the power-off switching instruction reception notification.

According to the mobile object control device according to Configuration 2, when the first processor is configured to receive the instruction to switch the mobile object between the power-on state and the power-off state, the second processor is notified that the instruction to switch the mobile object to the power-off state is received, thereby making it possible to save the first software in the new version in the first memory and save the second software in the new version in the second memory in a period in which the mobile object is in the power-off state.

(Configuration 3) The mobile object control device according to Configuration 2, in which the second processor is connected to a power switching circuit configured to switch the power-on state and the power-off state and the second processor switches the mobile object to the power-off state by using the power switching circuit when the second processor recognizes the power-off switching instruction reception notification, and the first processor receives the instruction to switch the mobile object to the power-off state by using the power-on/off reception unit and the first processor saves the first software in the new version in the first memory when the first processor recognizes that the mobile object is switched to the power-off state on the basis of a status of detection by a switching detection unit configured to detect an actuation state of the power switching circuit.

According to the mobile object control device according to Configuration 3, when the second processor is configured to control switching between the power-on state and the power-off state, the first processor recognizes that the second processor switches the mobile object to the power-off state on the basis of a status of the switching detection unit, thereby allowing the first processor and the second processor to both recognize that the mobile object is in the power-off state, and save the first software in the new version in the first memory and save the second software in the new version in the second memory.

(Configuration 4) The mobile object control device according to any one of Configurations 1 to 3, in which a region in which the first software in the old version is saved and a region in which the first software in the new version is saved are set in the first memory, a region in which the second software in the old version is saved and a region in which the second software in the new version is saved are set in the second memory, the first processor saves the first software in the new version in the first memory while the first processor keeps the first software in the old version saved in the first memory and the first processor continues using the first software in the old version without outputting the first software updatable notification to the second processor when the first processor fails to save the first software in the new version in the first memory, and the second processor saves the second software in the new version in the second memory while the second processor keeps the second software in the old version saved in the second memory and the second processor continues using the second software in the old version without outputting the second software updatable notification to the first processor when the second processor fails to save the second software in the new version in the second memory.

According to the mobile object control device according to Configuration 4, it is possible to continue controlling actuation of the mobile object control device by using the first software in the old version saved in the first memory and the second software in the old version saved in the second memory when the mobile object control device fails to save the first software in the new version in the first memory or when fails to save the second software in the new version in the second memory.

(Configuration 5) A mobile object control method that is executed by a mobile object control device including a first processor, a first memory in which first software to be used by the first processor is saved, a second processor, and a second memory in which second software to be used by the second processor is saved, the mobile object control method including: a step of outputting, by the first processor, a first software updatable notification to the second processor when the first processor saves the first software in a new version in the first memory to make the first software switchable from an old version to the new version; a step of outputting, by the second processor, a second software updatable notification to the first processor when the second processor saves the second software in a new version in the second memory to make the second software switchable from an old version to the new version; and a step of executing, by the first processor, first switching processing of switching the first software to be used from the old version to the new version and executing, by the second processor, second switching processing of switching the second software to be used from the old version to the new version when the first processor recognizes the second software updatable notification and the second processor recognizes the first software updatable notification.

The first processor and the second processor execute the mobile object control method according to Configuration 5, thereby making it possible to obtain workings and effects similar to those of the mobile object control device according to Configuration 1.

(Configuration 6) A non-transitory recording medium storing a program that is executed by a first processor and a second processor in a mobile object control device including the first processor, a first memory in which first software to be used by the first processor is saved, the second processor, and a second memory in which second software to be used by the second processor is saved, the program causing: the first processor to execute processing of outputting a first software updatable notification to the second processor when the first processor saves the first software in a new version in the first memory to make the first software switchable from an old version to the new version; the second processor to execute processing of outputting a second software updatable notification to the first processor when the second processor saves the second software in a new version in the second memory to make the second software switchable from an old version to the new version; and the first processor and the second processor to respectively execute first switching processing of switching the first software to be used from the old version to the new version and second switching processing of switching the second software to be used from the old version to the new version when the first processor recognizes the second software updatable notification and the second processor recognizes the first software updatable notification.

The first processor and the second processor execute the program according to Configuration 6, thereby making it possible to implement the configuration of the mobile object control device according to Configuration 1.

### REFERENCE SIGNS LIST

1 mobile object control device
2 SS switch
3 IG relay
10 first microcontroller
11 first processor
12 first memory
13 first communication circuit
20 second microcontroller
21 second processor
22 second memory
23 second communication circuit
30, 32, 33 input circuit
35 output circuit
50 terminal device
100 mobile object
120 first program
121 first software in an old version
122 first software in a new version
220 second program
221 second software in an old version
222 second software in a new version
W worker

What is claimed is:

1. A mobile object control device comprising:
a first processor;
a first memory in which first software to be used by the first processor is saved;
a second processor; and
a second memory in which second software to be used by the second processor is saved, wherein
the first processor outputs a first software updatable notification to the second processor when the first processor saves the first software in a new version in the first memory to make the first software switchable from an old version to the new version,
the second processor outputs a second software updatable notification to the first processor when the second processor saves the second software in a new version in the second memory to make the second software switchable from an old version to the new version, and
the first processor executes first switching processing of switching the first software to be used from the old version to the new version and the second processor executes second switching processing of switching the second software to be used from the old version to the new version when the first processor recognizes the second software updatable notification and the second processor recognizes the first software updatable notification.

2. The mobile object control device according to claim 1, wherein
the first processor includes a power-on/off reception unit configured to receive an instruction to switch the mobile object between a power-on state and a power-off state, and the first processor saves the first software in the new version in the first memory and outputs a power-off switching instruction reception notification to the second processor when the first processor receives an instruction to switch the mobile object to the power-off state by using the power-on/off reception unit, and
the second processor saves the second software in the new version in the second memory when the second processor recognizes the power-off switching instruction reception notification.

3. The mobile object control device according to claim 2, wherein
the second processor is connected to a power switching circuit configured to switch the power-on state and the power-off state and the second processor switches the mobile object to the power-off state by using the power switching circuit when the second processor recognizes the power-off switching instruction reception notification, and
the first processor receives the instruction to switch the mobile object to the power-off state by using the power-on/off reception unit and the first processor saves the first software in the new version in the first memory when the first processor recognizes that the mobile object is switched to the power-off state on a basis of a status of detection by a switching detection unit configured to detect an actuation state of the power switching circuit.

4. The mobile object control device according to claim 1, wherein
a region in which the first software in the old version is saved and a region in which the first software in the new version is saved are set in the first memory,
a region in which the second software in the old version is saved and a region in which the second software in the new version is saved are set in the second memory,
the first processor saves the first software in the new version in the first memory while the first processor keeps the first software in the old version saved in the first memory and the first processor continues using the first software in the old version without outputting the first software updatable notification to the second processor when the first processor fails to save the first software in the new version in the first memory, and
the second processor saves the second software in the new version in the second memory while the second processor keeps the second software in the old version saved in the second memory and the second processor continues using the second software in the old version without outputting the second software updatable notification to the first processor when the second processor fails to save the second software in the new version in the second memory.

5. A mobile object control method that is executed by a mobile object control device including
a first processor,
a first memory in which first software to be used by the first processor is saved,
a second processor, and
a second memory in which second software to be used by the second processor is saved, the mobile object control method comprising:
a step of outputting, by the first processor, a first software updatable notification to the second processor when the first processor saves the first software in a new version in the first memory to make the first software switchable from an old version to the new version;
a step of outputting, by the second processor, a second software updatable notification to the first processor when the second processor saves the second software in a new version in the second memory to make the second software switchable from an old version to the new version; and
a step of executing, by the first processor, first switching processing of switching the first software to be used from the old version to the new version and executing, by the second processor, second switching processing of switching the second software to be used from the old version to the new version when the first processor recognizes the second software updatable notification and the second processor recognizes the first software updatable notification.

6. A non-transitory recording medium storing a program that is executed by a first processor and a second processor in a mobile object control device including the first processor,
a first memory in which first software to be used by the first processor is saved,
the second processor, and
a second memory in which second software to be used by the second processor is saved, the program causing:
the first processor to execute processing of outputting a first software updatable notification to the second processor when the first processor saves the first software in a new version in the first memory to make the first software switchable from an old version to the new version;
the second processor to execute processing of outputting a second software updatable notification to the first processor when the second processor saves the second software in a new version in the second memory to make the second software switchable from an old version to the new version; and
the first processor and the second processor to respectively execute first switching processing of switching the first software to be used from the old version to the new version and second switching processing of switching the second software to be used from the old version to the new version when the first processor recognizes the second software updatable notification and the second processor recognizes the first software updatable notification.
